(19) United States
(12) Patent Application Publication
(10) Pub. No.: US 2006/0171681 A1
(43) Pub. Date: Aug. 3, 2006

(54) Method for recording a selectable audio source and method for linking the recorded audio to a picture in a portable electronic device

(75) Inventors: Shih-Chieh Chen, Taipei City (TW); Yueh-Chi Wang, Taipei City (TW); Chieh-Yu Chan, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/220,689

(22) Filed: Sep. 8, 2005

(30) Foreign Application Priority Data
Dec. 30, 2004 (TW) 093141390

(51) Int. Cl. H04N 7/04

(52) U.S. Cl. 386/96

(57) ABSTRACT

A method for recording a selectable audio source in a portable electronic device and method for linking the recorded audio to a picture in the portable electronic device. The method for recording a selectable audio source includes: (A) determining whether a plurality of audio input devices are provided, if not, then performing step (C); (B) recording an audio file from one of the audio input devices and outputting the audio file; and (C) recording an audio file from the audio input device and outputting the audio file. The method for linking the recorded audio to a picture further comprises a step of linking the recorded audio to the picture.

### BACKGROUND OF THE INVENTION

1. Field of the Invention

The present invention relates to a method for recording a selectable audio source and method for linking the recorded audio to a picture, and more particularly, to a method for recording a selectable audio source in a portable electronic device and method for linking the recorded audio to a picture in the portable electronic device.

2. Description of the Related Art

With improvements in electronics technology, the sizes of many electronic devices have reduced, as with PDAs or music players, and these portable electronic devices provide entertainment with robust operating capabilities.

As shown in FIG. 1, a multimedia player 10 capable of playing MP3 files (an audio file) comprises a built-in microphone 11, an audio encoder 12, a microprocessor 13, a memory 14, an audio decoder 15, and an audio amplifier 16. An input device 17 is mounted on a surface of the multimedia player 10, such as function keys. The built-in microphone 11 can receive an external audio signal, such as a user's voice, and output the audio signal to the audio encoder 12. The audio encoder 12 encodes the audio signal to output a coded signal to the microprocessor 13. The microprocessor 13 transforms the coded signal into an audio file and stores the audio file in the memory 14. The memory 14 is typically a non-volatile memory, such as a flash memory or a small hard disk. The audio file can be in any coding format such as MP3, WMA, AAC, OGG, RM, MIDI, PLP, M3U, PLS, WMX, CDA, AC3, or SACD formats. When the user wants to listen to music, the microprocessor 13 obtains the audio file from the memory 14 and outputs the file to the audio decoder 15. The audio decoder 15 decodes the audio file and outputs the audio signal to the audio amplifier 16. Finally, the audio amplifier 16 amplifies the audio signal and sends it to a headphone or a speaker.

There are many other audio sources that can provide audio signals, such as broadcast signals or another audio signal. However, the multimedia player 10 cannot identify the sources of audio signals and therefore cannot provide a corresponding service to record the audio signal for the users. Furthermore, the multimedia player 10 cannot link the recorded audio to a picture on the portable electronic device for simultaneously providing the users both visual and audio effects.

Therefore, it is desirable to provide a method for recording a selectable audio source and method for linking the recorded audio to a picture to mitigate and/or obviate the aforementioned problems.

### SUMMARY OF THE INVENTION

A method for recording a selectable audio source of the present invention comprises: (A) determining whether a plurality of audio input devices are provided, if not, then performing step (C); (B) recording an audio file from one of the audio input devices and outputting the audio file; and (C) recording an audio file from the audio input device and outputting the audio file.

A method of linking recorded audio to a picture of the present invention comprising: (A) determining whether to link the recorded audio to the picture; (B) determining whether a plurality of audio input devices are provided, if not, then performing step (D); (C) recording an audio file from one of the audio input devices and outputting the audio file; (D) recording an audio file from the audio input device and outputting the audio file; and (E) generating a link between the picture and the audio file.

The portable electronic device can be a multimedia player, which is used for playing the audio file format, such as MP3, WMA, AAC, OGG, RM, MIDI, PLP, M3U, PLS, WMX, CDA, AC3, or SACD format. Furthermore, the portable electronic device can be a PDA (personal digital assistant), and the picture can be any file format, such as GIF, JPG, TIF, PSD, EPS, AI, PNG, ICO, RAW, TGA or BMP formats.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram of a multimedia player.

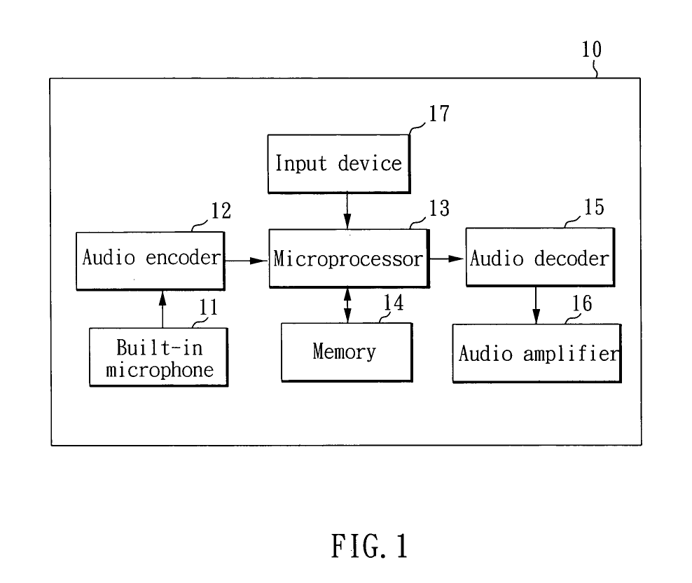

FIG. 2 is a flowchart of a method for recording a selectable audio source in a portable electronic device according to the present invention.

FIG. 3 is a flowchart of a method for linking the audio to a picture in the portable electronic device according to the present invention.

### DETAILED DESCRIPTION OF THE PREFERRED EMBODIMENT

According to the method for recording a selectable audio source in a portable electronic device of the present invention, the selectable audio source includes not only the audio file but also the external audio source. The external audio source would come from a microphone 11, an audio input line (linking to another audio player), or broadcast audio. The method for recording a selectable audio sources in a portable electronic device of the present invention can further link the recorded audio to a picture so the users may enjoy both visual and audio entertainment. Since there exists various portable electronic devices in the present market, the following embodiment adapts the multimedia player 10 as the best mode embodiment.

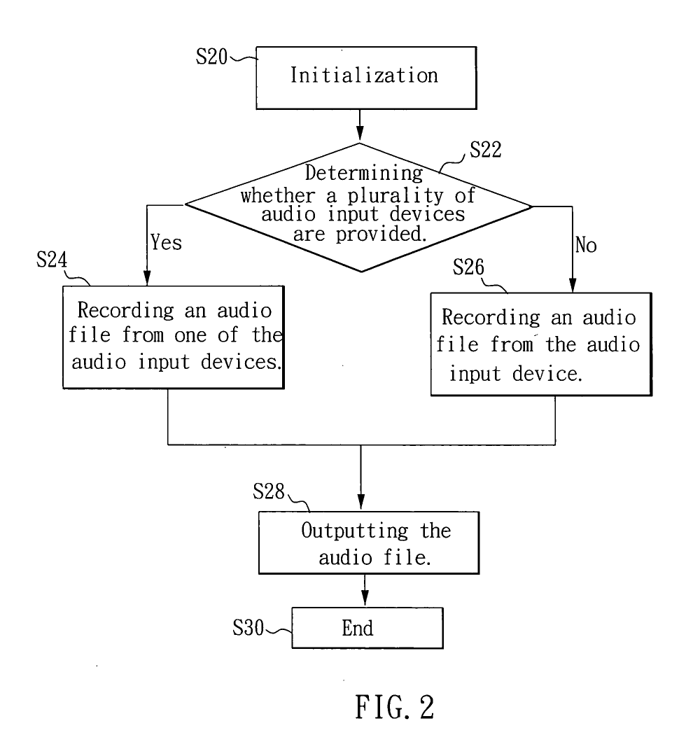

As shown in FIG. 2, the method for recording a selectable audio source in a portable electronic device of the present invention comprises the following steps:

Step S20: initialization.

Step S22: determining whether a plurality of audio input devices are provided; if so provided, recording an audio file from one of the audio input devices (step S24) and then outputting the audio file (step S28); if not, recording an audio file from the audio input device (step S26) and then outputting the audio file (step S28). The audio input devices include an audio playing software, the microphone 11, the audio source input cable, or the radio circuit. The external audio source inputted by the microphone 11 can be sound created by the users; the external audio source inputted by the audio source input cable can be music played by a CD player; the external audio source inputted by the radio circuit can be an FM broadcast; and the audio playing software can input an audio source being played by the multimedia player 10, such as MP3 music. If the multimedia player 10 playing an MP3 file provides a plurality of audio input devicessimultaneously, a user interface is called up for providing a plurality of audio input device options, so the users can select which of the audio input devices they want to record. In accordance with a user's option for the audio input device the multimedia player 10 playing the MP3 file proceeds to record. If the multimedia player 10 playing the MP3 file only provides one audio input device, the multimedia player 10 playing the MP3 file will directly record audio from the audio input device.

Step S30: end.

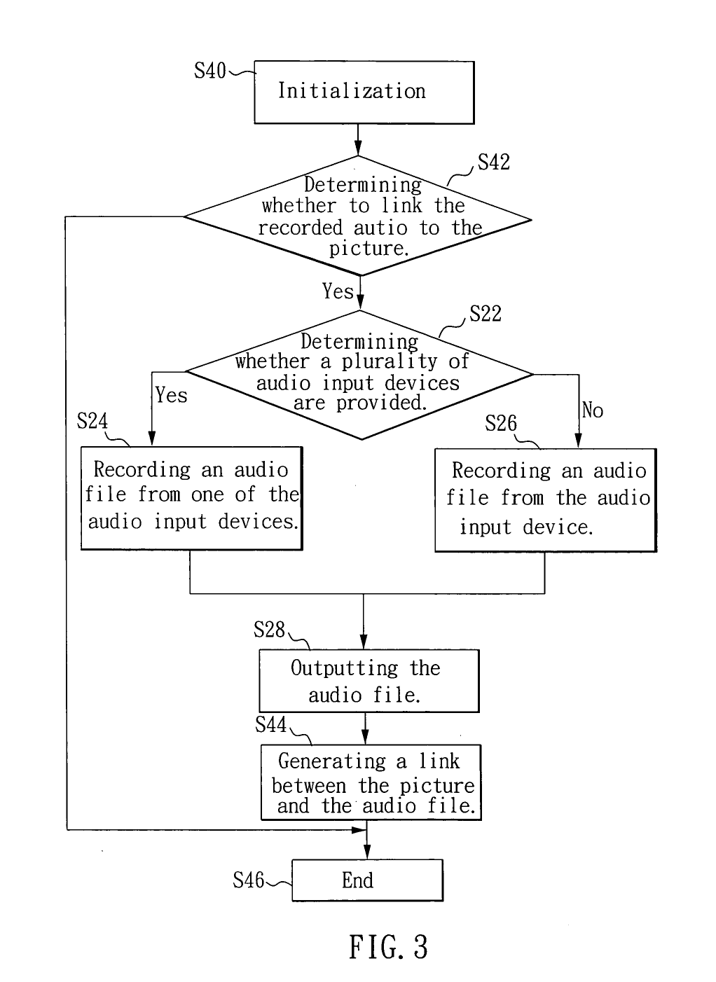

As shown in FIG. 3, the method for linking the recorded audio to a picture of the present invention comprises:

Step S40: initialization.

Step S42: determining whether to link the recorded audio to the picture. If it is to be linked, step S22 is performed; if it is not, step S46 is performed. The picture can be any file format, such as GIF, JPG, TIF, PSD, EPS, AI, PNG, ICO, RAW, TGA or BMP formats.

Step S22: determining whether a plurality of audio input devices are provided; if they are provided, recording an audio file from one of the audio input devices (step S24) and outputting the audio file (step S28); if not, recording an audio file from the audio input device (step S26) and outputting the audio file (step S28). Since step S22 to step S28 are identical in the foregoing description, therefore, a detailed description is deemed unnecessary.

Step S44: generating a link between the picture and the audio file.

Step S46: end.

According to the method of recording a selectable audio source of the present invention, the user can record an audio file from one of the audio input devices and link the recorded audio to the picture, so the user can view the picture with the sound.

Although the present invention has been explained in relation to its preferred embodiment, it is to be understood that many other possible modifications and variations can be made without departing from the spirit and scope of the invention as hereinafter claimed.

What is claimed is:

1. A method for recording a selectable audio source in a portable electronic device, the method comprising:
(A) determining whether a plurality of audio input devices are provided, if not, then performing step (C);
(B) recording an audio file from one of the audio input devices and outputting the audio file; and
(C) recording an audio file from the audio input device and outputting the audio file.

2. The method as claimed in claim 1, wherein the portable electronic device is a multimedia player.

3. The method as claimed in claim 2, wherein the multimedia player is an MP3 player.

4. The method as claimed in claim 2, wherein the multimedia player is a WMA player.

5. The method as claimed in claim 2, wherein the multimedia player is an RM player.

6. The method as claimed in claim 2, wherein the multimedia player is a MIDI player.

7. The method as claimed in claim 2, wherein the multimedia player is a PDA.

8. A method for linking recorded audio to a picture in a portable electronic device, the method comprising:
(A) determining whether to link the recorded audio to the picture;
(B) determining whether a plurality of audio input devices are provided, if not, then performing step (D);
(C) recording an audio file from one of the audio input devices and outputting the audio file;
(D) recording an audio file from the audio input device and outputting the audio file; and
(E) generating a link between the picture and the audio file.

9. The method as claimed in claim 8, wherein the portable electronic device is a multimedia player.

10. The method as claimed in claim 9, wherein the multimedia player is an MP3 player.

11. The method as claimed in claim 9, wherein the multimedia player is a WMA player.

12. The method as claimed in claim 9, wherein the multimedia player is an RM player.

13. The method as claimed in claim 9, wherein the multimedia player is a MIDI player.

14. The method as claimed in claim 9, wherein the multimedia player is a PDA.
